(19) United States
(12) Patent Application Publication
(10) Pub. No.: US 2019/0257723 A1
(43) Pub. Date: Aug. 22, 2019

(54) A LASER SPECTRAL IMAGING AND CAPTURE MICRODISSECTION MICROSCOPE

(71) Applicant: DAYLIGHT SOLUTIONS, INC., San Diego, CA (US)

(72) Inventors: Jeremy Rowlette, Escondido, CA (US); Benjamin Bird, Roslindale, MA (US); Nicholas McCollum, San Diego, CA (US)

(21) Appl. No.: 16/348,121

(22) PCT Filed: Nov. 8, 2017
(86) PCT No.: PCT/US2017/060561

§ 371 Date: May 7, 2019

Related U.S. Application Data
(60) Provisional application No. 62/419,294, filed on Nov. 8, 2016.

(51) Int. Cl. G01N 1/28; G01N 1/06

(52) U.S. Cl. CPC G01N 1/286; G01N 2001/2886; G01N 1/06

(57) ABSTRACT

An imaging and capture micro-dissection microscope (12) for spectrally analyzing a sample (10) and isolating a region of interest (210) in the sample (10) includes (i) a stage (26A) that retains the sample (10); (ii) an analysis laser assembly (14) that generates a coherent interrogation beam (16A) that is directed at the sample (10), the interrogation beam (16A) having a center wavelength that is in the infrared region; (iii) an image sensor (24A) that receives light from the sample (10), the image sensor (24A) capturing image information that is used to identify the region of interest (210) in the sample (10); (iv) a separation assembly (18) that separates the region of interest (210) from the sample (10) while the sample (10) is retained by the stage (26A); and (v) a capturing assembly (20) that captures the region of interest (210).

### RELATED APPLICATION

This application claims priority on U.S. Provisional Application No. 62/419,294, filed on Nov. 8, 2016, and entitled “A LASER SPECTRAL IMAGING AND CAPTURE MICRODISSECTION MICROSCOPE”. As far as permitted, the contents of U.S. Provisional Application No. 62/419,294 are incorporated herein by reference.

### BACKGROUND

Laser capture micro-dissection microscopes are used for isolating one or more microscopic regions from a sample for subsequent evaluation. As an example, a laser capture micro-dissection microscope can include a cutting laser that individually cuts the one or more microscopic regions from the sample, and a capturing assembly that individually captures each of the cut microscopic regions. Next, the captured, microscopic regions can be subsequently evaluated.

Unfortunately, existing methods for identifying the microscopic regions to be removed from the sample are not entirely satisfactory.

### SUMMARY

An infrared laser spectral imaging and microdissection microscope having a laser capture microdissection subassembly for spectrally analyzing a sample and physically isolating small regions of interest in the sample for subsequent analysis, includes (i) a stage that retains the sample; (ii) an imaging laser assembly that generates a substantially coherent interrogation beam that is directed at the sample while the sample is retained by the stage, the interrogation beam having a center wavelength that is in the infrared region; (iii) an image sensor that receives light from the sample, the image sensor capturing image information that is used to identify the region of interest in the sample, the image sensor being operable in the infrared range; and (iv) a separation assembly that physically separates the region of interest from the sample while the sample is retained by the stage. Additionally, the microscope can include a capturing assembly that captures the region of interest. As a result thereof, a single micro-dissection microscope can be used to both accurately identify and capture the regions of interest from the sample. This can greatly simplify and expedite the process of identifying and capturing the regions of interest with high confidence and process efficiency.

Additionally, the micro-dissection microscope can include an objective lens assembly that collects light from the sample and images the light on the image sensor, wherein the objective lens assembly includes at least one refractive element.

In one embodiment, the separation assembly includes a cutting laser source that directs a cutting beam at the sample that cuts the region of interest from the sample. Alternatively, the separation assembly includes a heating laser source that directs a heating beam at a thermoplastic positioned adjacent to the sample.

In a first embodiment, the analysis laser assembly is a mid-infrared, tunable laser assembly that is tunable so that the interrogation beam has an interrogation center wavelength of between 5000 to 12000 nanometers, and the separation assembly includes a cutting laser that is a pulsed, ultraviolet laser source and the cutting beam has a cutting center wavelength of between 315 to 400 nanometers.

In a second embodiment, the analysis laser assembly is a mid-infrared, tunable laser assembly that is tunable so that the interrogation beam has an interrogation center wavelength of between 5000 to 12000 nanometers, and the separation assembly includes a cutting laser that is a pulsed, mid-infrared laser and the cutting beam has a cutting center wavelength between 2000 nm and 3000 nm or approximately 2950 nanometers.

In a third embodiment, the analysis laser assembly is a mid-infrared, tunable laser assembly that is tunable so that the interrogation beam has an interrogation center wavelength of between 5000 to 12000 nanometers, and the separation assembly includes a thermoplastic heating laser that is a near-infrared, laser source and the heating beam has a heating center wavelength of between 700 to 1000 nanometers.

In a fourth embodiment, the analysis laser assembly is a mid-infrared, tunable laser assembly that is tunable so that the interrogation beam has an interrogation center wavelength of between 2600 to 3900 nanometers, and the separation assembly includes a cutting laser that is a pulsed, ultraviolet laser source and the cutting beam has a cutting center wavelength of between 315 to 400 nanometers.

In a fifth embodiment, the analysis laser assembly is a mid-infrared, tunable laser assembly that is tunable so that the interrogation beam has an interrogation center wavelength of between 2600 to 3900 nanometers, and the separation assembly including a cutting laser that is a pulsed, infrared laser source and the cutting beam has a cutting center wavelength of approximately 2950 nanometers.

In a sixth embodiment, the analysis laser assembly is a mid-infrared, tunable laser assembly that is tunable so that the interrogation beam has an interrogation center wavelength of between 2600 to 3900 nanometers, and the separation assembly includes a heating laser source that is a near-infrared laser source and the heating beam has a heating center wavelength of between 700 to 1000 nanometers.

In a seventh embodiment, the analysis laser assembly includes a first channel, mid-infrared, laser assembly that generates a first interrogation beam has an interrogation center wavelength of between 2600 to 3900 nanometers, and a second channel, mid-infrared, laser assembly that generates a second interrogation beam has an interrogation center wavelength of between 5000 to 12000 nanometers.

Additionally, the micro-dissection microscope can include a control system that includes a processor that controls the image sensor to capture two dimensional image information that is used to identify the region of interest in the sample. The control system can analyze the two dimensional image information to identify potential regions of interest in the sample. Subsequently, the control system can control the separation assembly to separate the identified potential region or regions of interest from the sample. The regions of interest may have contiguous boundaries which are rectilinear, polygonal, piece-wise-linear, circular, oval or any continguous shape that can be described with an interpolated polynomial or spline function.

Also, the present invention is directed to a method for analyzing a sample and isolating a region of interest in the sample. The method can include the steps of (i) retaining the sample with a stage; (ii) generating a substantially coherent interrogation beam that is directed at the sample while the sample is retained by the stage, the interrogation beam having a center wavelength that is in the infrared region; (iii) capturing an image of the sample with an image sensor that is operable in the infrared range; (iv) analyzing the image information to identify the region of interest in the sample; (v) separating the region of interest from the sample while the sample is retained by the stage with a separation assembly; and (vi) collecting the physical specimen in a capture vessel.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified schematic illustration of a first embodiment of an imaging and capture microscope having features of the present invention;

FIG. 2 is a simplified top illustration of sample that includes a plurality of regions of interest;

FIG. 3 is a simplified schematic illustration of a second embodiment of an imaging and capture micro-dissection microscope having features of the present invention;

FIG. 4 is a simplified schematic illustration of a third embodiment of an imaging and capture microscope having features of the present invention;

FIG. 5 is a simplified schematic illustration of a fourth embodiment of an imaging and capture microscope having features of the present invention; and

FIG. 6 provides examples whereby spectral features have been used to construct/create images that describe tissue regions of further interest.

### DESCRIPTION

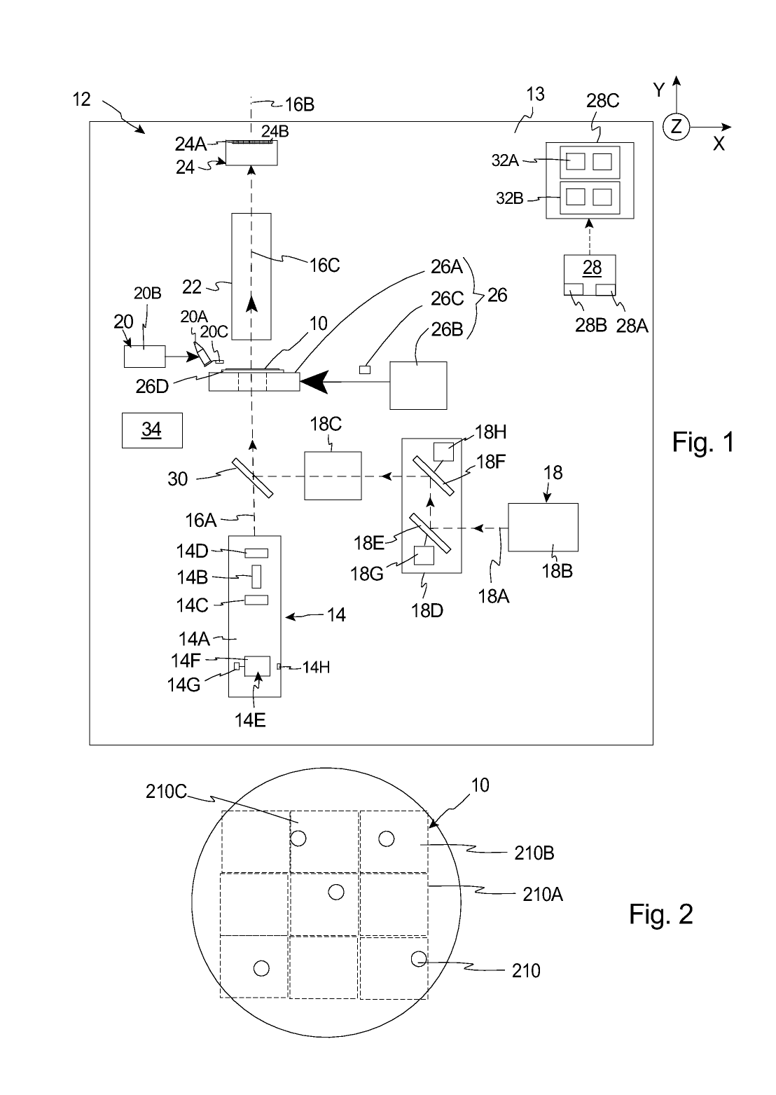

FIG. 1 is a simplified schematic illustration of a sample 10, and an imaging and capture microdissection microscope 12 that (i) spectrally analyzes the sample 10 with light to accurately identify one or more microscopic regions of interest 210 (illustrated as circles in FIG. 2), (ii) individually separates the regions of interest 210 from the rest of the sample 10, and/or (iii) individually captures the regions of interest 210. In certain embodiments, one or more of the separated sample regions of interest 210 can be captured in a container 20A (e.g. a capture vessel) such as microcentrifuge tube for subsequent analysis. As a result thereof, a single micro-dissection microscope 12 can be used to both identify and capture the regions of interest 210 from the sample 10. This can greatly simplify and expedite the process of identifying and capturing the regions of interest 210. Moreover, because light is used to analyze the sample 10, the regions of interest can be identified without adversely changing the chemical composition of the sample 10 (as what is done with staining).

Some of the Figures provided herein include an orientation system that designates a X axis, a Y axis, and a Z axis that are orthogonal to each other. In these Figures, the Z axis is oriented in the vertical direction. It should be understood that the orientation system is merely for reference and can be varied. For example, the X axis can be switched with the Y axis. Moreover, these axes can alternatively be referred to as a first, a second, or a third axis.

The size, shape and/or composition of the sample 10 can be varied. As non-exclusive examples, the sample 10 can include eukaryotes, erythrocytes, leukocytes, prokaryotes and tissues. Stated in another fashion, the sample 10 can be a variety of things, including mammalian blood, mammalian blood serum, mammalian cells, mammalian tissue, mammalian biofluids, and their animal counterparts, plant matter, bacteria, polymers, hair, fibers, explosive residues, powders, liquids, solids, inks, and other materials commonly analyzed using spectroscopy and microscopy.

In the embodiment illustrated in FIG. 2, the sample 10 is generally disk shaped. Alternatively, for example, the sample 10 can be rectangular shaped or have another configuration. Moreover, as non-exclusive examples, the sample 10 can have a cross-sectional area of 0.01, 0.1, 0.5, 1, 2, 4, 6, 10, 15, or more square centimeters.

Further, the sample 10 can be thin enough to allow study by transmission of an illumination beam through the sample 10 (i.e. in transmission mode), or the sample 10 can be an optically opaque sample that is analyzed through reflection of an illumination beam by the sample 10 (i.e. in reflection mode). Still further, the sample 10 can be thin enough to allow study through transflection of an illumination beam, e.g., an infrared illumination beam can pass through the sample 10, reflect on the surface of a reflective substrate, and again pass through the sample 10, the illumination beam being double attenuated.

Similarly the size, shape and/or composition of the regions of interest 210 can be varied. For example, the regions of interest 210 can be microscopic and include specific cells (e.g. subpopulations of tissue cells) that can be used to detect disease and/or other health related conditions. Alternatively, for example, the regions of interest 210 can be evaluated for the presence of explosive residues and/or other dangerous substances. In FIG. 2, each regions of interest 210 is generally disk shaped. Alternatively, for example, each regions of interest 210 may have contiguous boundaries which are rectilinear, polygonal, piece-wise-linear, circular, oval or any continguous shape that can be described with an interpolated polynomial or spline function be rectangular shaped or have another configuration. Moreover, as non-exclusive examples, each regions of interest 210 can have a cross-sectional area of 0.1, 0.5, 1, 2, 4, 6, 10, 15, 20, 10, 1000, or more square micrometers.

With the present invention, the regions of interest 210 can be accurately identified, and isolated for subsequent analysis. Stated in another fashion, the imaging and capture microscope 12 can be utilized for rapid screening of the sample 10 for the presence of regions of interest 210 which require additional testing. As non-exclusive examples, the subsequent analysis can include one or more of (i) DNA genotyping, (ii) loss-of-heterozygosity (LOH) analysis, (iii) RNA transcript profiling, (iv) cDNA library generation, (v) protein discovery, (vi) signal-pathway profiling, (vii) cancer genotyping and characterization, (viii) polymerase chain reaction (PCR), (ix) fluorescence in-situ hybridization (FISH), (x) mass spectrometry or (xi) proteomic analysis.

In one, non-exclusive embodiment, the imaging and capture microdissection microscope 12 includes (i) a rigid frame 13 that fixedly retains the other components; (ii) an analysis laser assembly 14 that generates one or more interrogation beams 16A (illustrated with a long dashed line) that are used to spectrally analyze the sample 10 to identify the regions of interest 210; (iii) a separation assembly 18 that is used to selectively direct one or more separating beams 18A (also referred to as a “cutting beam” or a “heating beam”) at the sample 10 to separate the regions of interest 210 from the sample 10; (iv) a capturing assembly 20 that individually captures each of the regions of interest 210 or captures multiple regions of interest 210; (v) an objective lens assembly 22; (vi) a light sensing device 24 that includes an image sensor 24A that senses light in the infrared, spectral region; (vii) a stage assembly 26; and (viii) a control system 28 that controls the components of the micro-dissection microscope 12. It should be appreciated that the design of each of the components of the imaging and capture micro-dissection microscope 12 can be varied to achieve the desired results. Additionally, the imaging and capture micro-dissection microscope 12 can be designed with more or fewer components than those specifically illustrated in FIG. 1, and/or the components can be organized in another fashion than as illustrated in FIG. 1.

The analysis laser assembly 14 generates the coherent interrogation beam 16A having an interrogation center wavelength that is directed at the sample 10 along a beam axis 16B to spectrally analyze the sample 10. The design of the analysis laser source 14 can be varied to suit the specific requirements of the micro-dissection microscope 12 and/or the characteristics of the sample 10 that is to be analyzed. In certain embodiments, the analysis laser assembly 14 is designed so that the interrogation beam 16A has a center wavelength that is in the infrared region. For example, the analysis laser assembly 14 can be designed to generate one or more interrogation beams 16A having a center wavelength that is in the mid-infrared spectral region. As utilized herein, the term “mid-infrared spectral region” or “MIR spectral region” shall mean and include the spectral region or spectral band of between approximately two and twenty micrometers (2-20 μm) or wavelengths of between approximately five thousand and five hundred (5000-500 cm⁻¹). The MIR spectral range is particularly useful to spectroscopically interrogate the unknown sample since many samples are comprised of molecules or groups of molecules that have fundamental vibrational modes in the MIR range, and thus present strong, unique absorption signatures within the MIR range. The interrogation beam 16A can include one or more pulses of light or a continuous pulse of light.

The analysis laser assembly 14 (i) can be a fixed wavelength laser that generates at a single center wavelength, or (ii) can be a tunable laser that sequentially spans a portion or all of the infrared spectral range. The analysis laser assembly 14 can include one or more individual lasers, or laser modules. For example, the analysis laser assembly 14 can be designed to include multiple lasers, with each laser being used to generate a different portion of the infrared range.

It should be appreciated that the analysis laser assembly 14 can employ a variety of methods to rapidly switch between the plurality of interrogation wavelengths. These include techniques such as rapid tuning mechanisms using electro-optical or acousto-optical filters, voice coil or galvo-controllled mirrors or semiconductor microfabricated mirrors based on microelectromechanical system (MEMS) technology to switch between different laser modules, or spectral beam combining techniques of multiple laser modules and subsequent time-division multiplexing of laser illumination.

In the non-exclusive example illustrated in FIG. 1, the analysis laser assembly 14 is a tunable, external cavity laser that includes a rigid laser frame 14A, a gain medium 14B, a cavity optical assembly 14C, an output optical assembly 14D, and a wavelength selective (“WS”) feedback assembly 14E (e.g., a movable grating). The design of each of these components can be varied to achieve the requirements of the present invention.

In one, non-exclusive embodiment, the gain medium 14B directly emits the interrogation beams 16 without any frequency conversion. As non-exclusive examples, the gain medium 14B can be a Quantum Cascade (QC) gain medium, an Interband Cascade (IC) gain medium, or an infrared diode. Alternatively, another type of gain medium 14B can be utilized. In FIG. 1, the gain medium 14B includes (i) a first facet that faces the cavity optical assembly 14C and the feedback assembly 14E, and (ii) a second facet that faces the output optical assembly 14D. In this embodiment, the gain medium 14B emits from both facets. In one embodiment, the first facet is coated with an anti-reflection (“AR”) coating, and the second facet is coated with a reflective coating. The AR coating allows light directed from the gain medium 14B at the first facet to easily exit as a beam directed at the WS feedback assembly 14E; and allows the light beam reflected from the WS feedback assembly 14E to easily enter the gain medium 14B. The interrogation beams 16 exits from the second facet. The partly reflective coating on the second facet of the gain medium 14B reflects at least some of the light that is directed at the second facet of the gain medium 14B back into the gain medium 14B.

The cavity optical assembly 14C can be positioned between the gain medium 14B and the WS feedback assembly 14E along a lasing axis. The cavity optical assembly 14C collimates and focuses the beam that passes between these components. For example, the cavity optical assembly 14C can include a single lens or more than one lens.

The output optical assembly 14D is positioned between the gain medium 14B and one of the beam steerers 20 in line with the lasing axis to collimate and focus the interrogation beams 16 that exits the second facet of the gain medium 14B. For example, the output optical assembly 14D can include a single lens or more than one lens that are somewhat similar in design to the lens of the cavity optical assembly 14C.

The WS feedback assembly 14E reflects the beam back to the gain medium 14B, and is used to precisely select and adjust the lasing frequency of the external cavity and the center wavelength of the pulses of light. In this design, the interrogation beams 16 may be tuned with the WS feedback assembly 14E without adjusting the gain medium 14B. Thus, with the external cavity arrangement disclosed herein, the WS feedback assembly 14E dictates what wavelength will experience the most gain and thus dominate the wavelength of the interrogation beams 16.

In some embodiments, the WS feedback assembly 14E includes a diffraction grating 14F and a grating mover 14G that selectively moves (e.g., rotates) the diffraction grating 14F to adjust the lasing frequency of the gain medium 14B and the interrogation wavelength of the interrogation beams 16A. The diffraction grating 14F can be continuously monitored with a measurement system 14H (e.g. an encoder) that provides for closed loop control of the grating mover 14G. With this design, the interrogation wavelength of the interrogation beams 16A can be selectively adjusted in a closed loop fashion so that the sample 10 can be imaged at the many different, interrogation wavelengths.

In certain embodiments, the analysis laser assembly 14 can include an illumination optical assembly (not shown) that directs the interrogation beams 16A at the sample 10. For example, the illumination optical assembly can be utilized to condense and/or adjust the size of the interrogation beams 16A, i.e. to increase (magnify) or decrease the size of the interrogation beams 16A, so that the interrogation beams 16A matches the desired field of view on the sample 10. In certain embodiments, the size of an illuminated area (not shown) of the sample 10 can be tailored to correspond to the design of the light sensing device 24 and the objective lens assembly 22. In one embodiment, the illumination optical assembly can include one or more refractive lenses that transform the interrogation beams 16A and/or assist in directing the interrogation beams 16 at the sample 10.

Additionally, in the embodiment illustrated in FIG. 1, the interrogation beams 16A exiting the analysis laser assembly 14 pass through a beam combiner 30 that allows for both the interrogation beams 16A and the separating beams 18A to be directed at the sample 10 along the same beam axis 16B and in the same direction. In one embodiment, the beam combiner 30 transmits the interrogation beams 16A and reflects the separating beams 18A. For example, the beam combiner 30 can be a Dichroic beam combiner that is ultraviolet reflective and infrared transmissive. With this design, the infrared interrogation beams 16A pass through the beam combiner 30, while the separating beams 18A are reflected. Alternatively, for example, the location of the analysis laser assembly 14 and the separation assembly 18 can be switched and the beam combiner 30 can be designed to reflect the interrogation beams 16A and transmit the separating beams 18A.

The separation assembly 18 selectively separates the one or more regions of interest 210 from the sample 10. In one embodiment, the separation assembly 18 includes a cutting laser 18B that generates the cutting beam 18A having a cutting center wavelength. For example, the cutting laser 18B can be a continuous or a pulsed, ultra-violet laser.

Optionally, the separation assembly 18 can include a refractive objective lens assembly 18C that transforms and focuses the cutting beam 18A. For example, the lens assembly 18C can include one or more refractive elements and/or an optional f-theta lens.

Additionally, the separation assembly 18 can optionally also include a beam steering assembly 18D that can be used to steer and scan the cutting beam 18A relative to the sample. In FIG. 1, the beam steering assembly 18D is a two axis beam galvo pair beam steering assembly 18D that includes a first mirror 18E, a spaced apart, second mirror 18F, a first mirror mover 18G (illustrated as a box), and a second mirror mover 18H (illustrated as a box). With this design, the position of the mirrors 18E, 18F can individually be adjusted by the respective mirror mover 18G, 18H under the control of the control system 28 to move (scan) the cutting beam 18A relative to the sample 10 to selectively cut the regions of interest 210 from the sample 10. Each mirror mover 18G, 18H can include one or more actuators. Alternatively, or additionally, the stage assembly 26 can be controlled to move the sample 10 relative to the cutting beam 18A to selectively cut the regions of interest 210 from the sample 10.

Alternatively, the separation assembly 18 can include an infrared heating laser source (not shown in FIG. 1) that heats a thermoplastic 20C to the sample 10 at the region of interest 210 to bond (e.g. fuse) the thermoplastic 20C to the sample 10 at the region of interest 210. Subsequently, the thermoplastic 20C can be removed to separate the region of interest 210 from the rest of the sample 10.

The following is a non-exclusive list of possible analysis laser assembly 14 and separation assembly 18 combinations include: (i) the analysis laser assembly is a mid-infrared, tunable laser assembly that is tunable so that the interrogation beam has an interrogation center wavelength of between 5000 to 12000 nanometers, and the cutting laser source is a pulsed, ultraviolet laser source and the cutting beam has a cutting center wavelength of between 315 to 400 nanometers; (ii) the analysis laser assembly is a mid-infrared, tunable laser assembly that is tunable so that the interrogation beam has an interrogation center wavelength of between 5000 to 12000 nanometers, and the cutting laser source is a pulsed, mid-infrared laser and the cutting beam has a cutting center wavelength of approximately 2950 nanometers; (iii) the analysis laser assembly is a mid-infrared, tunable laser assembly that is tunable so that the interrogation beam has an interrogation center wavelength of between 5000 to 12000 nanometers, and the heating laser source is a near, infrared, laser source and the heating beam has a heating center wavelength of between 700 to 1000 nanometers; (iv) the analysis laser assembly is a mid-infrared, tunable laser assembly that is tunable so that the interrogation beam has an interrogation center wavelength of between 2600 to 3900 nanometers, and the cutting laser source is a pulsed, ultraviolet laser source and the cutting beam has a cutting center wavelength of between 315 to 400 nanometers; (v) the analysis laser assembly is a mid-infrared, tunable laser assembly that is tunable so that the interrogation beam has an interrogation center wavelength of between 2600 to 3900 nanometers, and the cutting laser source is a pulsed, infrared laser source and the cutting beam has a cutting center wavelength of approximately 2950 nanometers; or (vi) the analysis laser assembly is a mid-infrared, tunable laser assembly that is tunable so that the interrogation beam has an interrogation center wavelength of between 2600 to 3900 nanometers, and the cutting laser source is a near-infrared laser source and the cutting beam has a cutting center wavelength of between 700 to 1000 nanometers.

In yet another embodiment, the analysis laser assembly 14 is a fixed dual-band MIR laser source. For example, the analysis laser assembly 14 can include a first channel MIR laser source having a first interrogation beam centered between 2600-3900 nm, and a second channel MIR laser source having a second interrogation beam centered between 5000-12000 nm. In these examples, the separation assembly 18 can include an ultraviolet or infrared cutting laser or a near, infrared heating laser source with center wavelength of between 700 to 1000 nanometers.

The capturing assembly 20 individually captures the regions of interest 210 that are separated from the sample 10. For example, the capturing assembly 20 can include an individual container 20A (only one is shown in FIG. 1) for each region of interest 210, and a container mover 20B that individually moves and positions the containers 20A. With this design, each region of interest 210 can be positioned in a separate sealed container 20A for subsequent processing. Alternatively, the capturing assembly 20 can be designed to capture multiple regions of interest 210 is the same container 20A.

The design of the capturing assembly 20 will vary according to the design of the separation assembly 18. For example, if the separation assembly 18 includes a heating laser that fuses the thermoplastic 20C to the sample 10, the capturing assembly 20 can tear out the region of interest 210 by pulling on the thermoplastic 20C and placing the thermoplastic 20C in the container 20A. In certain embodiments, the lid of the container 20A can be the thermoplastic 20C that is fused to the portion of the sample 10. Alternatively, the thermoplastic 20C can be separate from the container 20A.

In a different embodiment, for example, if the separation assembly 18 uses a cutting laser 18B, after cutting the region of interest 210 from the rest of the sample, the region of interest 210 can be catapulted from rest of the sample 10 by directing a defocused ultraviolet laser pulse from the cutting laser 18B which generates a photonic force to propel the region of interest 210 into the container 20A. However, other capturing methods can alternatively be used.

The objective lens assembly 22 collects the light 16C from the sample 10 and images the light field from the sample plane 16C onto the image sensor 24A. In FIG. 1, the objective lens assembly 22 collects the light 16C transmitted through the sample 10 and images that light 16C onto the plane of the image sensor 24A. The objective lens assembly 22 include one or more, spaced apart, refractive elements that are optimized for coherent light, in the infrared spectral range. In this embodiment, the objective lens assembly 22 is a compound refractive objective lens assembly.

The image sensor 24A receives light 16C from the sample 10, and the image sensor 24A captures image information that is used to identify the regions of interest 210 in the sample 10. In one embodiment, the image sensor 24A is a two dimensional sensor array of pixels 24B (only a few are illustrated) that receives and/or senses the light 16C and generates two dimensional image information that is used by the control system 28 to generate a two dimensional image 32 of the sample 10. In certain embodiments, the image sensor 24A is operable in the infrared spectral range. More particularly, the light sensing device 24 can be a mid-infrared camera that is sensitive to the mid-infrared spectral region from two to twenty μm. In this embodiment, the image sensor 24A senses mid-infrared light and converts the infrared light into an array of electronic signals that represents an image of the sample 10. In certain embodiments, the image sensor 24A includes a two-dimensional array of photosensitive elements (pixels) 24B (e.g., a focal plane array (FPA)) that are sensitive to the wavelength of the interrogation beams 16A, i.e., that are sensitive to the infrared region of the electromagnetic spectrum. Additionally, the two-dimensional array of pixels 24B can be used to construct a two-dimensional image 32 including the two-dimensional array of data (data at each pixel 24B). The spacing between the pixel elements 24B is referred to as the pitch of the array. As non-exclusive examples, the two-dimensional array can include approximately 640×480; 320×240; 480×480; 80×60; 1080×720; 120×120; 240×240; 1080×1080, 1920×1080, 1080×720, or 640×480 pixels, with pixel sizes ranging from one micron (μm) up to two hundred microns (μm).

The term “image” as used herein shall mean and include a two-dimensional digital image or screen display, or a two-dimensional array of data that can be used to generate the two-dimensional digital image or screen display.

In certain alternative embodiments, the image sensor 24A can have a measurement band that is approximately equal to the entire infrared spectral range; or the light sensing device 24 and/or the image sensor 24A can have a measurement band that is approximately equal to a predetermined desired range within the MIR spectral range. Further, in certain embodiments, the light sensing device 24 can block and not sense light outside the desired measurement band. Thus, it should be appreciated that the design of the light sensing device 24 can be adjusted to match the desired requirements of the system.

Non-exclusive examples of suitable infrared image sensors 24A include (i) vanadium oxide (VOx) microbolometer arrays such as the FPA in the FLIR Tau 640 infrared camera that are typically responsive in the seven to fourteen μm spectral range but can also be made to have spectral response from three to 14 um range; (ii) mercury cadmium telluride (HgCdTe or MCT) arrays such as those in the FLIR Orion SC7000 Series cameras that are responsive in the 7.7 to 11.5 μm spectral range; (iii) indium antimonide (InSb) arrays such as those in the FLIR Orion SC7000 Series cameras that are responsive in the 1.5 to 5.5 μm spectral range; (iv) indium gallium arsenide (InGaAs); (v) uncooled hybrid arrays involving VOx and other materials from DRS that are responsive in the two to twenty μm spectral range; or (vi) any other type of image sensor that is designed to be sensitive to infrared light in the two to twenty μm range and has electronics allowing reading out of each element's signal level to generate a two-dimensional array of image information.

The stage assembly 26 retains and accurately positions the sample 10 during the spectral imaging using the analysis laser assembly 14 and during separating with the separation assembly 18. In one embodiment, the stage assembly 26 includes a stage 26A, a stage mover 28B, and a stage measurement system 28C. In this embodiment, the stage 26A includes a sample holder 26D that retains the sample 10. As alternative, non-exclusive examples, the sample holder 26D can be (i) a standard medical grade glass slides; (ii) a glass slide having a polymer coating such as polyethylene naphthalate (PEN); (iii) a glass slide having an energy transfer coating (such as one sold by Expression Pathology at http://www.expressionpathology.com/director_slides.shtml); (iv) an LCM membrane slides (e.g a polyethylene naphthalate (PEN) sold by thermofisher at https://www.thermofisher.com/order/catalog/product/LCM0522; (v) infrared transparent slides such as CaF2, BaF2, Si, Ge, ZnSe, ZnS, etc; or (iv) infrared transparent slides with polymer membrane material. In these examples, the sample holder 26D is transmissive to interrogation beams 16A and the separating beam 18A.

PEN membrane slides 26D enable the combined use of an infrared analysis laser assembly and an ultraviolet cutting laser. PEN Membrane Glass Slides allows the use of standard infrared LCM on its own, which is the gentlest approach for isolating individual cells or small areas. PEN Membrane Frame Slides provide additional flexibility by allowing the choice of micro-dissection from non-dehydrated sample preparations.

The stage mover 26B can be controlled by the control system 28 to precisely move and position the stage 26A and the sample 10 during spectral analysis with the analysis laser assembly 14 and cutting with the cutting laser 18B. With this design, the stage mover 26B can be controlled so that the desired portion of the sample 10 is being spectrally analyzed, and subsequently the stage mover 26B can be controlled to remove the desired region of interest 210.

For example, the stage mover 26B can be used to position the stage 26A and the sample 10 along the X, Y and Z axes and about the X, Y and Z axes. Alternatively, for example, the stage mover 26B can be designed to position the stage 26A and the sample 10 along the X and Y axes and about Z axis. For example, the stage mover 26B can include one or more motors, linear actuators, voice coil motors, piezo electric drives or other actuators. Additionally and/or alternatively, the stage 26A can be manually positioned as desired.

The stage measurement system 26C provides accurate information regarding the position of the stage 16A and/or the sample 10 to the control system 28 for close loop feedback control of the stage mover 26B. For example, the stage measurement system 26C can include one or more interferometers, encoders or other measurement systems.

The control system 28 controls the various components of the laser micro-dissection microscope 12 and includes one or more processors 28A, electronic data storage devices 28B, and/or a display 28C (e.g. an LED display). For example, the control system 28 can control one or more components of the laser micro-dissection microscope 12, receive information from the pixels 24B of the image sensor 24A, generate one or more images 32A (four are illustrated as boxes) of the sample 10 from the pixel information, and/or subsequently generate one or more spectral cubes 32B (two are illustrated as boxes) of the sample 10 using the images 32A. Additionally, the control system 28 can evaluate the spectral infrared images 32A of the sample 10 at the various interrogation wavelengths to identify and/or recommend the one or more regions of interest 210.

In alternative, non-exclusive embodiments, the control system 28 can control the image sensor 24A to capture two dimensional image information at a frame rate of approximately (i) thirty frames per second, (ii) sixty frames per second, or (iii) one hundred and twenty frames per second. Thus, the system provides live spectral imaging. However, other frame rates can be utilized.

Depending upon the design of the microscope 12 and the size of the sample 10, the microscope 12 can be controlled to generate one or more spectral infrared images 32A that are used spectrally analyze the entire sample 10 at one time to identify the regions of interest 210, and subsequently separate and capture the regions of interest 210. In this example, the microscope 12 has a field of view which is approximately the size of the sample 10, and the entire sample 10 can be evaluated at one time. In this example, the entire sample 10 is the analyzed sample area 210A (illustrated in FIG. 2).

Alternatively, if the sample 10 is larger than the field view of the microscope 12, the sample 10 can be organized into a plurality of adjacent or partly overlapping sample areas 210A (nine are illustrated in FIG. 2 as boxes in phantom) based on the size of the field of view. In this embodiment, each of the sample areas 210A can be sequentially analyzed by the microscope 12.

The size of the field of view of the microscope 12 can be varied by varying the design of the components such as the image sensor 24 and the illumination optical assembly. As alternative, non-exclusive examples, the microscope 12 can have a field of view of approximately 400 microns, 500 microns, 650 microns, 900 microns, one millimeter, two millimeters, or five millimeters.

As a simplified example, for each sample area 210A, the control system 28 can control the analysis laser assembly 14 so that the center wavelength of the illumination beam 12 is varied over time, over a tunable wavelength range (e.g. the entire or a portion of the MIR range) to generate the illumination beam 16A with the center wavelength that sequentially varies over time while the image sensor 24A is controlled to capture images 32A at one or more target center wavelengths.

More specifically, for a first sample area 210B, the stage assembly 26 moves the sample 10 to position the first sample area 210B in the field of view. Subsequently, the laser assembly 10 can be tuned, and one or more pulses can be generated having approximately the same first center wavelength (“first target wavelength”) while capturing a first image. Subsequently, the laser assembly 10 can be tuned, and one or more pulses can be generated having approximately the same second center wavelength (“second target wavelength”) while capturing a second image. Next, the laser assembly 10 can be tuned, and one or more pulses can be generated having approximately the same third center wavelength (“third target wavelength”) while capturing a third image. In this example, each target wavelength is different and each target wavelength can be in the MIR spectral range. This process can be repeated with a plurality of additional target wavelengths throughout a portion or the entire tunable wavelength range to generate the plurality of images 32A for the spectral cube 32B for the first sample area 210B.

It should be noted that the number of different target wavelengths required to effectively analyze the sample 10 and the corresponding number of images 32A in the spectral cube 32B used to identify the regions of interest 210, and the specific target wavelengths utilized by the laser micro-dissection microscope 12 will vary according to the sample 10 that is being analyzed. As non-exclusive examples, the number of discrete target wavelengths and images 32A in the spectral cube 32B for each sample area 210A can be approximately 1, 2, 3, 4, 5, 6, 7, 8, 9, 10, 15, 20, 25, 40, 200, 226, 400, 552 or 4000.

Next, the stage assembly 26 can move the sample 10 until a second sample area 210C is in the field of view. Subsequently, the plurality of images 32A of the second sample area 210C can be sequentially captured at different target wavelengths to generate the spectral cube for the second sample area 210C. This process can be repeated for the remaining sample areas 210A.

With this design, the microscope 12 can be used to quickly and accurately acquire a separate spectral cube 32B for each sample area 210A that can be used to analyze and evaluate the various properties of the sample 10.

After all of the desired sample areas 210A are spectrally analyzed, the control system 28 and/or an operator of the system can analyze the images 32A/spectral cubes 32B to suggest and/or identify the regions of interest 210A. Next, the stage assembly 26, the separation assembly 18 and the capturing assembly 20 can be controlled by the control system 28 to separate and capture the regions of interest 210A.

Alternatively, after one of the sample areas 210A is spectrally analyzed, the control system 28 and/or an operator of the system can analyze the images 32A/spectral cubes 32B to suggest and/or identify the regions of interest 210 in that sample area 210A. Next, the stage assembly 26, the separation assembly 18 and the capturing assembly 20 can be controlled by the control system 28 to capture the regions of interest 210 in that sample area 210A. Next, this process can be repeated for subsequent sample areas 210A.

Thus, as provided herein, the laser micro-dissection microscope 12 uses tunable mid-infrared radiation 16 to rapidly spectrally interrogate and identify one or more regions of interest 210 in the sample 10.

As provided herein, after the one or more infrared spectral images 32A are generated, the control system 28 can use the information from one or more of the images 32 to identify or suggest one or more possible regions of interest 210 in the sample 10. For example, the user of the microscope 12 can push a button, either physically or virtually through a graphical user interface, to start the infrared spectral analysis of the sample 10. The spectral analysis of the sample 10 may include the automated spectral imaging of whole slides or substantial regions of a standard slide typically having dimensions of one by three inches to produce absorbance contrast images in the mid-infrared spectral region. This rapid spectral imaging step is followed by an automated pixel segmentation based on the spectral and/or shape content mapped to a pixel location. After the spectral analysis is complete the user can review the captured spectral images, either in raw spectral format or as a mathematically reduced data presentation format, to manually identify the regions of interest 210. Alternatively, the control system 28 can review the information from the infrared spectral analysis to pinpoint and identify possible regions 210 that may require further analysis. Subsequently, the user can push a button to approve of one or more of the possible regions of interest 210, and the control system 28 can control the separation assembly 18 and the capturing assembly 20 to individually capture the regions of interest 210 for further testing.

Still alternatively, the entire process can be automated with the user of the microscope 12 first pushing a button, either physically or virtually through a graphical user interface, to start the infrared spectral analysis of the sample 10. After the spectral analysis is complete, the control system 28 again reviews the information from the infrared spectral analysis to pinpoint and identify possible regions 210 that may require further analysis. In this design, the control system 28 automatically controls the separation assembly 18 and the capturing assembly 20 to individually capture the regions of interest 210 identified with the control system 28 without input from the user.

It should be noted that with the infrared spectral analysis provided herein that the regions of interest 210 can be identified without adding chemicals, labels, antibodies or dyes to the sample 10. Stated in another fashion, the process provided herein does not alter or damage the morphology or the chemistry of the regions of interest 210 collected, nor the surrounding cells. This process generates an unadulterated sample which will more accurately depict the native cellular physical and chemical structures and local environment. This additionally increases the flexibility, accuracy, and specificity of the subsequent testing that can be performed on the regions of interest 210.

FIG. 2 is a simplified top illustration of sample 10 that includes five regions of interest 210. It should be noted that this is merely an example, and the sample 10 can include more than five or less than five regions of interest 210.

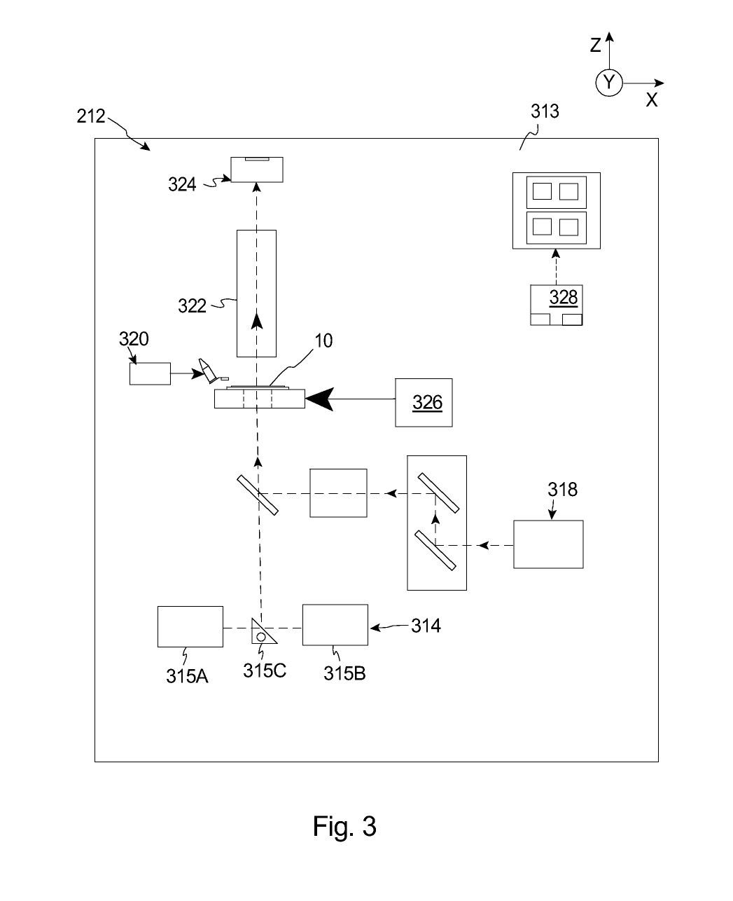

FIG. 3 is a simplified schematic illustration of a second embodiment of a laser spectral imaging and capture micro-dissection microscope 312 that is used to analyze and cut the sample 10 In this embodiment, (i) the frame 313; (ii) the separation assembly 318; (iii) the capturing assembly 320; (iv) the objective lens assembly 322; (v) the light sensing device 324; (vi) the stage assembly 326; and (vii) the control system 328 are similar to the corresponding component described above and illustrated in FIG. 1. However, in this embodiment, the analysis laser assembly 314 includes a first channel, mid-infrared, laser assembly 315A that generates a first interrogation beam having a first interrogation center wavelength; a second channel, mid-infrared, laser assembly 3158 that generates a second interrogation beam having a second interrogation center wavelength; and a selector 315C (e.g. a rotatable galvo). In this embodiment, each laser assembly 315A, 315B (i) can be a fixed laser that generates a different, single center wavelength, or (ii) can be a tunable laser that spans a different portion of the infrared spectral range. Further, the selector 315C and be controlled by the control system 328 to select which beam is being directed at the sample 10.

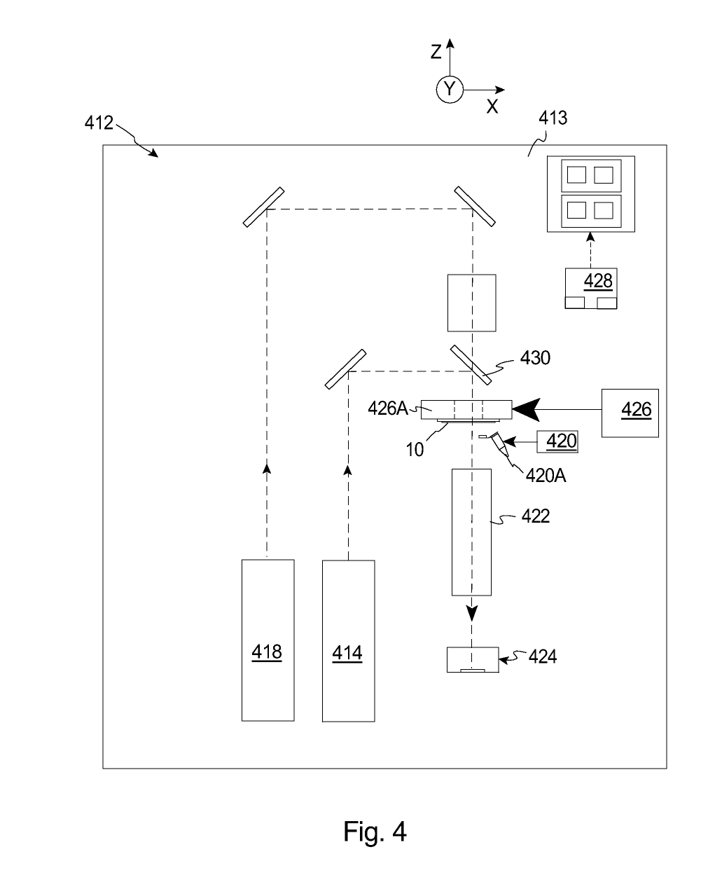

FIG. 4 is a simplified schematic illustration of a third embodiment of an imaging and capture micro-dissection microscope 412 that is used to analyze and cut the sample 10 In this embodiment, (i) the frame 413; (ii) the analysis laser assembly 414; (iii) the separation assembly 418; (iv) the capturing assembly 420; (v) the objective lens assembly 422; (vi) the light sensing device 424; (vii) the stage assembly 426; and (viii) the control system 428 are somewhat similar to the corresponding component described above and illustrated in FIG. 1. However, in this embodiment, the positioning of the components is slightly different and the sample 10 is positioned below the stage 426A. With this design, for example, when the region of interest 210 (illustrated in FIG. 2) is cut from the sample 10, it can simply fall into the container 420A of the capturing assembly 420.

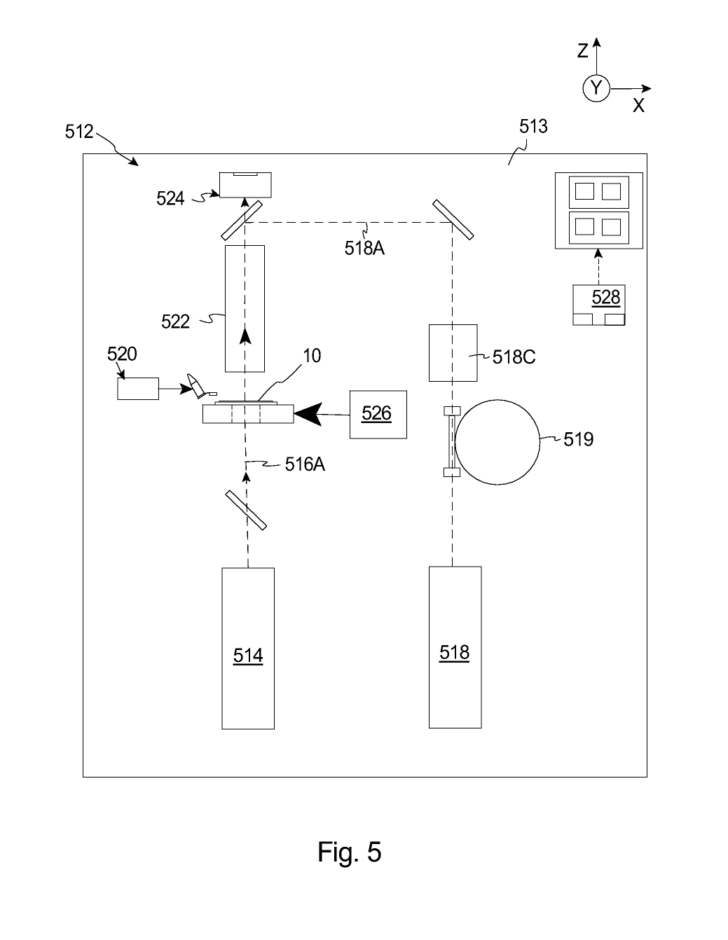

FIG. 5 is a simplified schematic illustration of a fourth embodiment of an imaging and capture micro-dissection microscope 512 that is used to analyze and cut the sample 10 In this embodiment, (i) the frame 513; (ii) the analysis laser assembly 514; (iii) the separation assembly 518 including the objective lens assembly 518C; (iv) the capturing assembly 520; (v) the objective lens assembly 522; (vi) the light sensing device 524; (vii) the stage assembly 526; and (viii) the control system 528 are somewhat similar to the corresponding component described above and illustrated in FIG. 1. However, in this embodiment, the positioning of the components is slightly different than that illustrated in FIG. 1. With the design illustrated in FIG. 5, the interrogation beam 516A and the separation beam 518A are directed in different directions at the sample 10. Further, separation assembly 518 can include a fiber coupler 519.

As provided above, the present invention provides one or more unique methods to identify the regions of interest on one or more samples.

Almost all materials have a unique mid-infrared spectrum, which describe absorption features that relate to the vibrational modes of chemical moieties within molecules.

The infrared imaging microscope 12 described above and illustrated in FIG. 1, can be used to record spectroscopic hypercubes from the sample 10, where the first 2 dimensions describe a two dimensional spatial area of the sample 10, and the 3rd dimension a mid-infrared spectrum recorded at that discrete location. Such spectroscopic images can be used to analyze and evaluate various properties of the sample 10. The type of sample 10 and the regions of interest 210 can be varied. For example, as provided above, the sample 10 can include eukaryotes, erythrocytes, leukocytes, prokaryotes and tissues. For example, the regions of interest 210 can be microscopic and include specific cells (e.g. subpopulations of tissue cells).

Spectral features used for identification of different “region of interest” 210 can include, but are not limited to: (i) a measured intensity value at a discrete frequency; (ii) the integrated intensity or area under the curve of a spectral region; (iii) the ratio of values reported in (i) and (ii) above; and/or (iv) any values in (i)-(iii) after the data has been transformed from absorbance to another format, for example a derivative. Further, various forms of data analysis or compression, such as wavelet transform and/or PCA analysis can be used to identify the spectral features and/or compress the data. These spectral features can be used to create images that identify regions of interest, or serve as input into supervised classification algorithms that create images that identify regions of interest for further analysis.

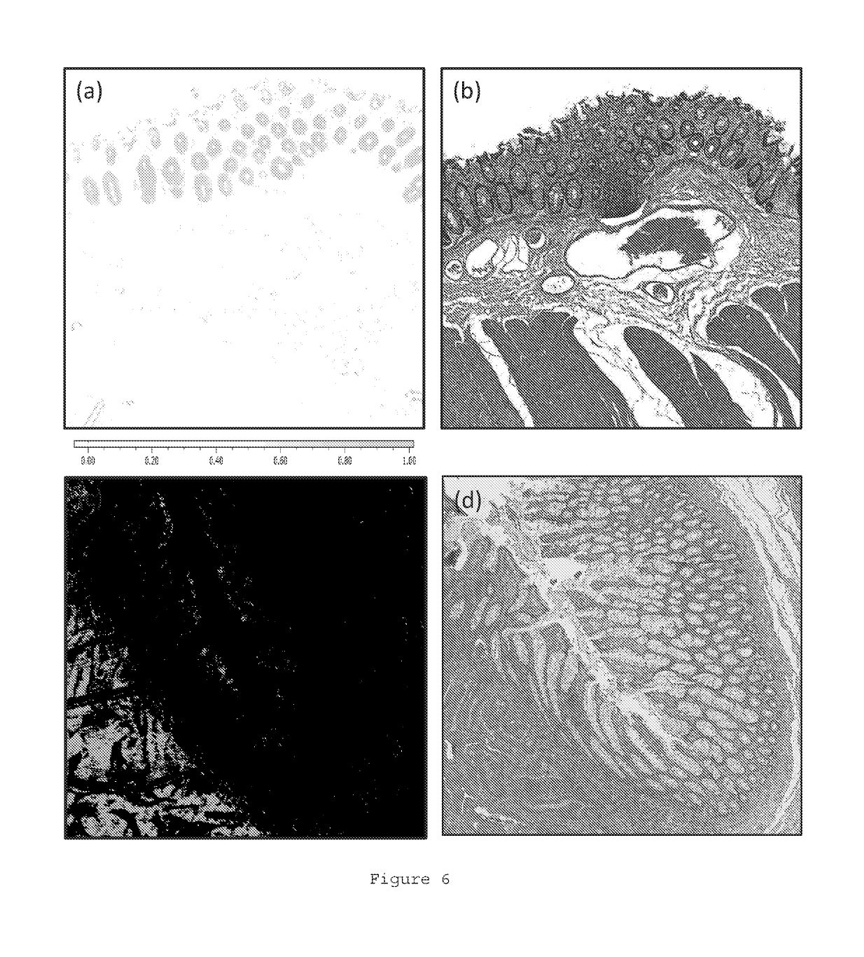

As a non-exclusive example, the subsequent analysis can include the examination of a colorectal tissue section. FIG. 6, provides examples whereby spectral features have been used to construct/create images that describe tissue regions of further interest. FIG. 6a displays an image that identifies regions on a colorectal tissue section that describe goblet cells, rich in the glycoprotein mucin. A brightfield image captured from a parallel H&E stained section is used for reference in FIG. 6b. The image in FIG. 6a was constructed by the calculation of the peak height at 1044 cm⁻¹ (strongest mucin glycosylation spectral band). The measurement was linear baseline corrected using intensity values recorded at 1180 and 940 cm⁻¹. The intensity image produced was mapped against a white-gray (min-max) colour palette. FIG. 6c display an image that identifies regions of adenocarcinoma on a colorectal tissue section. A brightfield image captured from a parallel H&E stained section is used for reference in FIG. 6d. The image in FIG. 6a was constructed using a Random Forest Classifier that was trained (75 trees) and applied using the measured 2^{nd} derivative intensity values recorded between 1800 and 900 cm⁻¹. The classification intensity image produced was mapped against a white-red (min-max) colour palette.

The measured spectra from samples can be altered or confounded by a number of sample or substrate mediated scattering effects. These include, but are not limited to: (i) mixing of absorptive and reflective line shapes; (ii) Mie scattering; (iii) resonant Mie (RMie) scattering, and/or (iv) optical standing wave artifact. As a consequence, the mid-infrared spatially resolved microscopic analysis of structurally heterogeneous samples, with complex morphological structures and refractive index mediated scattering artifacts, can be problematic for accurate sample classification or region of interest identification, and may require computational correction. This can include, (i) subtraction of linear or polynomial baselines calculated from pivot points in the spectra, (ii) the use of iterative algorithms such as the Lieber (C. A. Lieber, A. Mahadevan-Jansen, Automated Method for Subtraction of Fluorescence from Biological Raman Spectra, Appl. Spec. 57 (2003) 1363, the contents of which are incorporated herein by reference); Eilers (P. H. C. Eilers, and H. F. M. Boelens, Technical report, Leiden University Medical Center, (2005), the contents of which are incorporated herein by reference); Bassan (Paul Bassan, Ashwin Sachdeva, Achim Kohler, Caryn Hughes, Alex Henderson, Jonathan Boyle, Jonathan H. Shanks, Michael Brown, Noel W. Clarke and Peter Gardner, FTIR microscopy of biological cells and tissue: data analysis using resonant Mie scattering (RMieS) EMSC algorithm, Analyst (2012), 137 1370-1377, the contents of which are incorporated herein by reference); Lukacs algorithms (R. Lukacs, R. Blumel, B. Zimmerman, M. Bagcioglu and A. Kohler, Recovery of absorbance spectra of micrometer-sized biological and inanimate particles, Analyst (2015), 140, 3273, the contents of which are incorporated herein by reference); or (iii) phase correction type algorithms (such as disclosed in (i) M. Miljkovic, B. Bird and M. Diem, Line shape distortion effects in infrared spectroscopy, Analyst (2012), 134, 3954-3964, and (ii) M. Romeo and M. Diem, Correction of dispersive line shape artifacts observed in diffuse reflection infrared spectroscopy and absorption/reflection (transflection) infrared micro-spectroscopy”, Vibrational Spectroscopy, 38, 129-132 (2005), the contents of which are incorporated herein by reference).

The measured spectra from different samples may provide intensity changes caused by differences in cellular density and tissue thickness. Thus, spectral features can be normalized to account for these differences. A number of normalization types exist and can be used that include (i) mean centering, (ii) standard normal variate, (iii) constant sum, (iv) constant sum of squares, (v) maximum amplitude (vi) Q normalization.

The measured spectra may also be pre-processed to reduce noise. A number of algorithms exist and can be used that include (i) the Maximum Noise Fraction Transform (See A. A. Green, M. Berman, P. Switzer, M. D. Craig, A Transformation for Ordering Multispectral Data in Terms of Image Quality with Implications for Noise Removal, IEEE Transactions on Geoscience and Remote Sensing, 26 (1988) 65-74, the contents of which are incorporated herein by reference); (ii) PCA reconstruction (See, I. T. Jolliffe, Principal Component Analysis, 2nd Edition, Springer, 2002, the contents of which are incorporated herein by reference); and/or (iii) Noise-Adjusted PCA reconstruction (See C.-I Chang, Q. Du, Interference and Noise-Adjusted Principal Components Analysis, IEEE Transactions of geoscience and remote sensing, vol 37, NO 5, September 1999, 2387, the contents of which are incorporated herein by reference).

In another, non-exclusive embodiment, the microscope 12 can be modified to include an automated slide handing and loading mechanism 34 (illustrated in FIG. 1 as a box) with ability to place and retrieve the sample 10 on the stage 26. In one non-exclusive embodiment, this component 34 could be capable of handling two hundred, 1×3 inch microscope slides. Additionally, this component may incorporate a bar code reader to automatically log the sample identity in the control system 28. Corresponding bar codes can be places on the sample slide and capture container 20A.

While a number of exemplary aspects and embodiments of a laser micro-dissection microscope 12 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. An imaging and capture microdissection microscope for analyzing a sample and isolating a region of interest in the sample comprising:
a stage that retains the sample;
an analysis laser assembly that generates a coherent interrogation beam that is directed at the sample while the sample is retained by the stage, the interrogation beam having a center wavelength that is in the infrared region;
an image sensor that receives light from the sample, the image sensor capturing image information that is used to identify the region of interest in the sample, the image sensor being operable in the infrared range; and
a separation assembly that physically separates the region of interest from the sample while the sample is retained by the stage.

2. The imaging and capture microdissection microscope of claim 1 further comprising a capturing assembly that captures the region of interest after it is separated from the sample with the separation assembly.

3. The imaging and capture microdissection microscope of claim 1 further comprising an objective lens assembly that collects light from the sample and forms an image of the sample on the image sensor, wherein the objective lens assembly includes at least one refractive element.

4. The imaging and capture microdissection microscope of claim 1 wherein the separation assembly includes a cutting laser source that directs a cutting beam at the sample that physically cuts the region of interest from the sample.

5. The imaging and capture microdissection microscope of claim 1 wherein the separation assembly includes a heating laser source that directs a heating beam at a thermoplastic positioned adjacent to the sample.

6. The imaging and capture microdissection microscope of claim 1 wherein the analysis laser assembly is a mid-infrared, tunable laser assembly that is tunable so that the interrogation beam has an interrogation center wavelength of between 5000 to 12000 nanometers, and the separation assembly includes a cutting laser that is a pulsed, ultraviolet laser source and the cutting beam has a cutting center wavelength of between 315 to 400 nanometers.

7. The imaging and capture microdissection microscope of claim 1 wherein the analysis laser assembly is a mid-infrared, tunable laser assembly that is tunable so that the interrogation beam has an interrogation center wavelength of between 5000 to 12000 nanometers, and the separation assembly includes a cutting laser that is a pulsed, mid-infrared laser and the cutting beam has a cutting center wavelength between 2000 nm and 3000 nm, or approximately 2950 nanometers.

8. The imaging and capture microdissection microscope of claim 1 wherein the analysis laser assembly is a mid-infrared, tunable laser assembly that is tunable so that the interrogation beam has an interrogation center wavelength of between 5000 to 12000 nanometers, and the separation assembly includes a thermoplastic heating laser that is a near, infrared, laser source and the heating beam has a heating center wavelength of between 700 to 1000 nanometers.

9. The imaging and capture microdissection microscope of claim 1 wherein the analysis laser assembly is a mid-infrared, tunable laser assembly that is tunable so that the interrogation beam has an interrogation center wavelength of between 2600 to 3900 nanometers, and the separation assembly includes a cutting laser that is a pulsed, ultraviolet laser source and the cutting beam has a cutting center wavelength of between 315 to 400 nanometers.

10. The imaging and capture microdissection microscope of claim 1 wherein the analysis laser assembly is a mid-infrared, tunable laser assembly that is tunable so that the interrogation beam has an interrogation center wavelength of between 2600 to 3900 nanometers, and the separation assembly including a cutting laser that is a pulsed, infrared laser source and the cutting beam has a cutting center wavelength of approximately 2950 nanometers.

11. The imaging and capture microdissection microscope of claim 1 wherein the analysis laser assembly is a mid-infrared, tunable laser assembly that is tunable so that the interrogation beam has an interrogation center wavelength of between 2600 to 3900 nanometers, and the separation assembly includes a heating laser source that is a near-infrared laser source and the heating beam has a heating center wavelength of between 700 to 1000 nanometers.

12. The imaging and capture microdissection microscope of claim 1 wherein the analysis laser assembly includes a first channel, mid-infrared, laser assembly that generates a first interrogation beam has an interrogation center wavelength of between 2600 to 3900 nanometers, and a second channel, mid-infrared, laser assembly that generates a second interrogation beam has an interrogation center wavelength of between 5000 to 12000 nanometers.

13. The imaging and capture microdissection microscope of claim 1 further comprising a control system that includes a processor that controls the image sensor to capture two dimensional image information that is used to identify the region of interest in the sample.

14. The imaging and capture microdissection microscope of claim 1 wherein the control system analyzes the two dimensional image information to identify a potential region of interest in the sample.

15. The imaging and capture microdissection microscope of claim 1 wherein the control system controls the separation assembly to separate the identified potential region of interest from the sample.

16. The imaging and capture microdissection microscope of claim 1 wherein the center wavelength of the substantially coherent interrogation beam is modulated about the center wavelength so as to reduce the temporal coherence of the beam.

17. The imaging and capture microdissection microscope of claim 1 wherein the laser dissection and capture process is performed simultaneously while the mid-infrared spectral imaging is being performed.

18. A method for analyzing a sample and isolating a region of interest in the sample, the method comprising:
retaining the sample with a stage;
generating a coherent interrogation beam that is directed at the sample while the sample is retained by the stage, the interrogation beam having a center wavelength that is in the infrared region, the image sensor being operable in the infrared range;
capturing image information from the sample with an image sensor that is operable in the infrared range;
analyzing the image information to identify the region of interest in the sample; and
separating the region of interest from the sample while the sample is retained by the stage with a separation assembly.

19. The method of claim 18 further comprising capturing the region of interest with a capturing assembly.

20. The method of claim 18 further including collecting light from the sample and forming an image of the sample on the image sensor with an objective lens assembly, wherein the objective lens assembly includes at least one refractive element.

21. The method of claim 18 wherein the step of separating includes directing a cutting beam at the sample that cuts the region of interest from the sample with a cutting beam.

22. The method of claim 18 wherein the step of separating includes directing a heating beam at a thermoplastic positioned adjacent to the sample.
